(19) United States
(12) Patent Application Publication
(10) Pub. No.: US 2009/0204952 A1
(43) Pub. Date: Aug. 13, 2009

(54) METHOD OF SECURING A COMPUTER PROGRAM. AND CORRESPONDING DEVICE, METHOD OF UPDATING AND UPDATE SERVER

(75) Inventor: David Naccache, Paris (FR)

Correspondence Address: David D. Brush;WESTRMAN, CHAMPLIN & KELLY,P.A., Suite 1400, 90 Second Avenue South, Minieapolis, MN, 55402-3319, US

(73) Assignee: Compagnie Industrielle Et Financiere D'Ingenierie "Ingenico", Neuilly Sur Seine (FR)

(21) Appl. No.: 12/368,762

(22) Filed: Feb. 10, 2009

(30) Foreign Application Priority Data
Feb. 12, 2008 (FR) 08/50883

(51) Int. Cl. G06F 9/44; G06F 15/16

(52) U.S. Cl. 717/131; 709/217; 717/126

(57) ABSTRACT

A method for securing use of a primary computer program driving at least one data receiving and delivery device. The method implements a secondary computer checking program, different from the primary program and capable of delivering the same output data as at least a portion of the primary program, referred to as the critical portion, in the presence of identical input data. The following steps are performed when at least one of the critical portions of the primary program is activated: executing the critical portion, delivering first output data based on input data; executing the checking program, delivering second output data based on the input data; comparing the first and second output data and generating anomaly information, if the first and second output data are different; transmitting the anomaly information to a remote server; and continuing the primary program, based on the first and second output data.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of securing computer programs. The disclosure relates more particularly to the ongoing checking of computer programs and the detection of errors or anomalies in these computer programs.

The disclosure applies in particular to computer programs for critical applications, e.g., in secure bank card payment systems, in means of transport such as aircraft, or else in industrial sites such as nuclear power plants.

### BACKGROUND OF THE DISCLOSURE

Testing techniques are already known, which enable a computer program (or software) to be checked and to flag possible operating errors or anomalies (called “bogues” in French and “bugs” in English).

Generally, a set of sample input data is applied, which is assumed to be representative of the use that will be made of the program, and the output data is checked for conformity with the data anticipated by the specification. Once the testing period for the computer program has been completed, the computer program is “released” (installed, distributed or marketed) and can, for example, drive a device into which it is integrated.

The presence of bugs in critical computer programs can have troublesome or serious repercussions for the device(s) that they drive/control. Computer programs used in applications requiring high accuracy and/or strong security are thus critical, e.g., in transportation systems (piloting of aircraft, railway signalling, software onboard motor vehicles), energy production (monitoring of nuclear power plants), health (medical devices), the financial field (electronic payment) or military applications.

The precautions to be taken in developing such a critical computer program are generally defined by the instructing party, or set by a standard, the high requirements of which require testing of the computer program in a large number of configurations, so as to strive for flawless operation of the critical computer program. Thus, during the testing period for the critical computer program, an attempt is made to maximize checking of the computer program by sending thereto the greatest possible number of sequences or different stimuli.

However, it is impossible to exhaustively test a computer program, and particularly a critical computer program, insofar as the testing period is often a compromise between time and completeness. Furthermore, these tests, for example, may not cover atypical or difficult to anticipate uses, or changes in certain aspects over time. It is understand that it is generally not possible to cover all possibilities, and that the more exhaustive the testing phase is, the longer it is, which proportionately delays the actual implementation of the program.

### SUMMARY

An aspect of the disclosure relates to a method of securing the use of a primary computer program driving at least one data receiving and delivery device.

According to an aspect of the disclosure, this method implements a secondary computer checking program, which is different from said primary program and which is capable of delivering the same output data as at least a portion of said primary program, referred to as the critical portion, in the presence of identical input data.

A securing method according to an aspect of the disclosure such as this includes the following steps, when at least one of said critical portions of said primary program is activated:
execution of said critical portion, delivering first output data based on input data;
execution of said checking program, delivering second output data based on said input data;
comparison of said first and second output data and generation of anomaly information, if said first and second output data are different;
transmission of said anomaly information to a remote server with a view to non-real time analysis and correction of said primary program;
continuation of said primary program, based on said first and second output data.

An aspect of the disclosure thus enables on-going and unimpeded testing of a program, particularly a primary program which is used for a critical application, even after the testing phase thereof. To accomplish this, an aspect of the disclosure implements a checking (test) program in parallel with the primary program, at least for the critical portions of this primary program. This implementation is carried out during the “production” phase of the primary program, when, for example, the primary program is actually driving a data receiving and delivery device, such as an electronic payment terminal, for example.

Parallel execution of the primary program and the checking program enables detection of an anomaly or anomalies (bug) in the primary program at any time during the production phase. In this way, it possible to detect the presence of an anomaly at any moment, when the output data of the two programs are different for the same input data. In the case of a discrepancy between this output data, anomaly information is generated and then transmitted to a remote server, without interrupting the primary program.

In other words, an aspect of the disclosure enables on-going checking of a primary program and the detection of bugs, not only during the testing period for the primary program but also during the production period of the primary program.

An aspect of the disclosure is also efficient, since checking of the primary program is based on “actual” input data, which could not have been anticipated during the testing period for the primary program, because it corresponds to an atypical use, for example. An aspect of the disclosure thus enables the use of a computer program to be secured on an on-going and continuous basis, without stopping the execution of same.

The transmission of anomaly information to a remote server makes it possible to quickly and efficiently flag possible anomalies, and to advantageously take the required corrective measures with respect thereto (which can be disseminated to a fleet of machines, if the same program is implemented on all of these machines, and not only to the one which flagged the anomaly).

In one particular embodiment, the transmission step includes the transmission of a report containing a set of information relating to said anomaly, including said input data and said output data, which is intended to enable identification of the origin of the anomaly and the correction thereof.

This enables the origin of the anomaly and the required correction to be determined more quickly.

According to one advantageous embodiment, the method includes a step of receiving information for correcting said primary program, which is transmitted by said server.

In this way, in response to the detection of an anomaly, an aspect of the disclosure enables correction information to be transmitted by a remote server to the device driven by the primary program (and, where appropriate, to other devices using this program). The device is thus capable of securing the use of the primary program, without there being any prolonged interruption in the operation thereof.

The method can likewise include, in addition to or alternatively, a step of receiving a command for interrupting or modifying said primary program, which is transmitted by said server.

In this way, the server can remotely control the modification of the primary program of the device or the interruption of the primary program, if the detected anomaly so requires it, or the modification of the behaviour of the primary program, e.g., for it to shift to a degraded or secure operating mode, in particular to prevent the anomaly from reproducing (e.g., by preventing the use of the portion of the code having generated the anomaly) and/or to mitigate the possible consequences of the anomaly (e.g., by blocking the bank card which generated the anomaly, by flagging the anomaly to the user (in particular in a vehicle or on an industrial site), and/or by securing the device, the equipment thereof or the environment thereof (in particular for military or nuclear applications)).

According to another aspect, the method includes a step for storing a report containing a set of information relating to said anomaly.

A report can thus be stored in the device driven by the primary program, e.g., before being stopped by the consequences of the anomaly. In this case, the device can transmit this report to the remote server at a later time

An aspect of the disclosure likewise relates to a device comprising data processing means, executing a primary program and implementing the above-described method.

A device such as this includes means of implementing a secondary computer checking program, which is different from said primary program and which is capable of delivering the same output data as at least a portion of said primary program, referred to as the critical portion, in the presence of identical input data. When at least one of said critical portions of said primary program is activated, it implements:
means of executing at least one of said critical portions of said primary program, delivering first output data based on input data;
means of executing said checking program, delivering second output data based on said input data;
means of comparing said first and second output data and generation of anomaly information, if said first and second output data are different;
means of transmitting said anomaly information to a remote server with a view to non-real time analysis and correction of said primary program; said means of executing said primary program continues processing on the basis of said first output data.

According to various particular embodiments, a device such as this may, in particular, belong to the group comprising:
smart card-reading terminals, in particular bank terminals;
data servers, in particular bank servers;
financial or stock transaction devices;
devices for monitoring medical applications, and particularly drug administration;
engine control devices;
railway signalling devices;
aircraft piloting devices;
on-board motor vehicle devices;
devices for monitoring industrial sites, particularly energy production (nuclear power plants, for example);
telecommunications devices;
devices used in military applications.

An aspect of the disclosure likewise relates to a method for updating a primary computer program driving at least one data receiving and delivery device, which implements the securing method of the disclosure, comprising the following steps:
reception of anomaly information transmitted by one of said devices, when the comparison of first data delivered by a primary program in the presence of particular input data differs from second output data delivered by a checking program;
analysis of said anomaly and production of a corrective measure;
transmission of said corrective measure to said device issuing said anomaly information.

As explained above, the approach of an aspect of the disclosure does indeed enable simple and effective correction and updating of such a primary program, once an anomaly has been detected by the checking program, even though this primary program is in the production phase.

According to one advantageous embodiment, said corrective measure is transmitted simultaneously to a set of devices using said primary program.

This enables simultaneous correction of a primary program in several devices which use the same primary program.

An aspect of the disclosure likewise relates to an update server for a primary program driving at least one data receiving and delivery device, implementing the securing method of the invention, comprising:
means for receiving anomaly information transmitted by one of said devices, when the comparison of first data delivered by a primary program in the presence of particular input data differs from second output data delivered by a checking program;
means of analyzing said anomaly and production of a corrective measure;
means of transmitting said corrective measure to said device issuing said anomaly information.

### BRIEF DESCRIPTION OF THE DRAWINGS

### List of Figures

Other characteristics and advantages will become more apparent upon reading the following description of one particular embodiment, given for non-limiting and illustrative purposes, and from the appended drawings, in which:

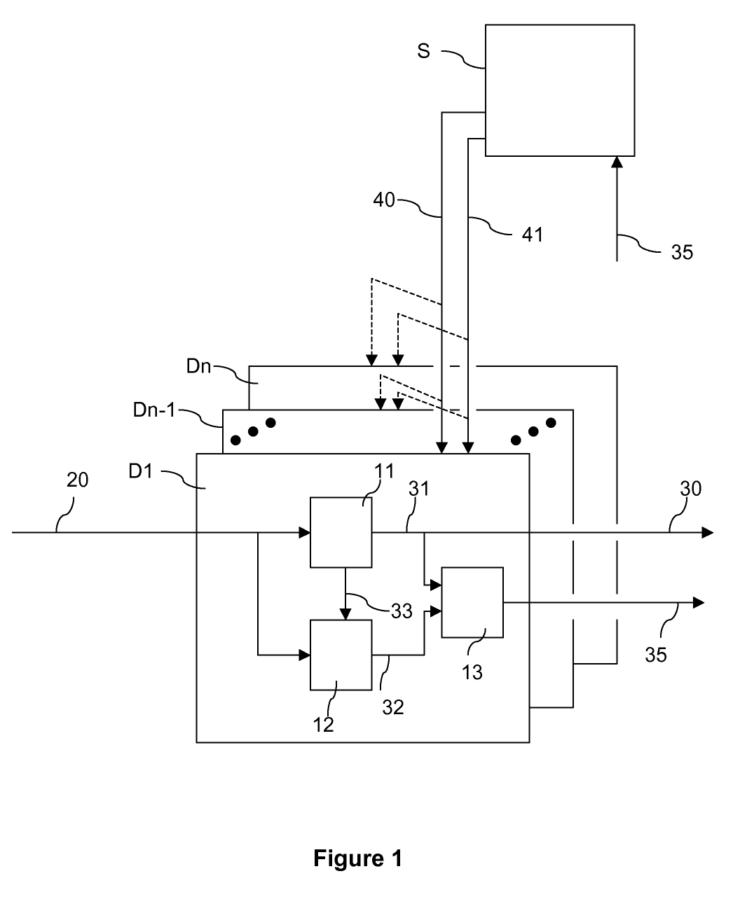

FIG. 1 is a schematic illustration of an exemplary system in which an aspect of the disclosure is implemented;

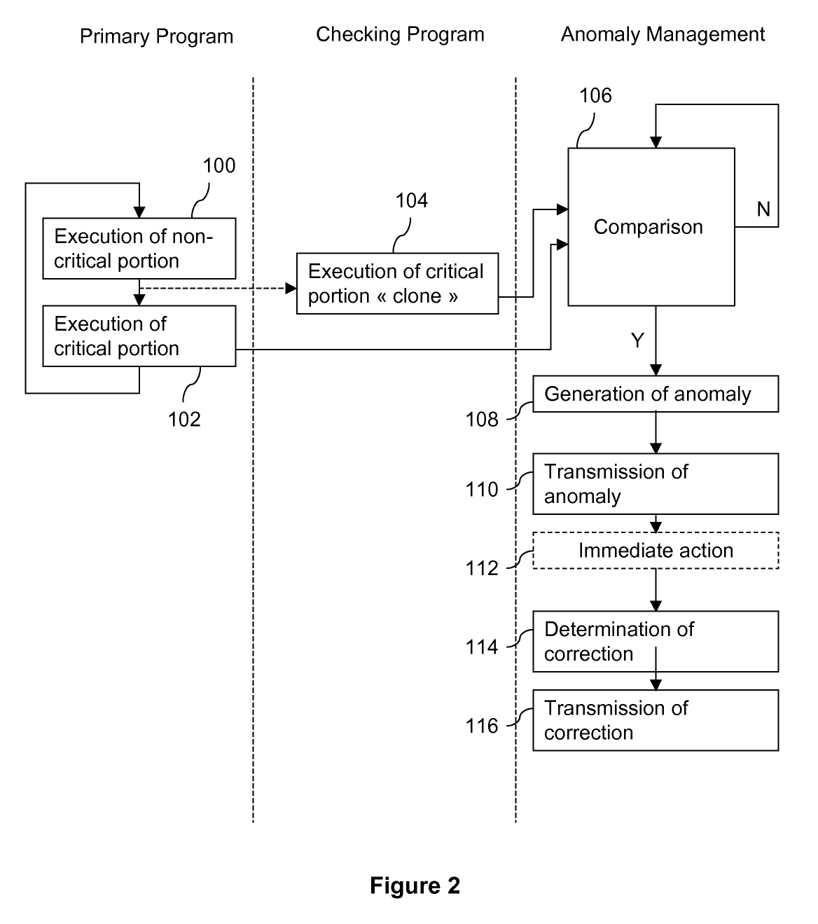

FIG. 2 shows the principal steps of a securing method according to one embodiment of the disclosure, which is adapted to the system of FIG. 1;

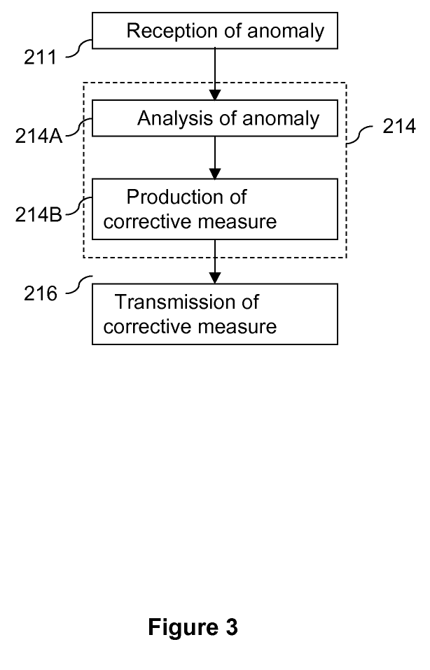

FIG. 3 shows the principal steps of an updating method according to one embodiment of the disclosure, which is adapted to the system of FIG. 1.

### DETAILED DESCRIPTION OF ILLUSTRATIVE EMBODIMENTS

The basic principle of an aspect of the disclosure is based on on-going and unimpeded checking of a computer program referred to as the primary program. This checking is carried out during the “production phase” of the primary program, i.e., after a conventional testing phase, when, for example, the primary program is driving a data receiving and delivery device.

To accomplish this, a checking program is executed in parallel with a primary program, at least during the execution of the critical portions of the primary program. This enables the detection of an anomaly or anomalies in the primary program, by comparing the results (outputs) of the two programs. More precisely, the presence of an anomaly is detected when the output data of the two programs are different for the same input data. In the case of a discrepancy between this output data, anomaly information is generated and then transmitted to a remote server, without interrupting the primary program, and thus in a manner transparent to the users.

FIG. 1 is a schematic representation of an exemplary system in which an aspect of the disclosure is implemented. The system illustrated includes several devices D1 to Dn each of which can be used in a critical application. Device D1, for example, can be a smart card-reading terminal (e.g., a bank terminal), a data server (e.g., a bank server), a device for monitoring medical applications (in particular drug administration), or an engine control device.

Device D1 includes data processing means, means for receiving input data 20 and means for delivering output data 30. The data processing means of device D1 conventionally include means of implementing a primary computer program 11 which includes one or more critical portions, i.e., critical code portions, and/or portions handling critical information.

According to an aspect of the disclosure, the processing means of device D1 also include means of implementing a secondary computer checking program 12. The secondary checking program 12 is different from the primary program 11, but is capable of delivering the same output data as the critical portions of the primary program 11, in the presence of identical input data. In other words, the secondary checking program 12 includes elements which are, in principle, identical to the critical portions of the primary program 11.

The primary program 11, for example, was generated by a first compiler, from a source code and given specifications. As concerns the checking program 12, it may have been developed directly by a programmer, or generated by a second compiler separate from the first one.

Implementation of the checking program 12 enables the critical portions of the primary program 11 to be tested and secured in accordance with the securing method of an aspect of the disclosure, the principal steps of which are detailed in FIG. 2.

It is assumed here that the primary program 11 is executed by the processing means of device D1 and that a non-critical portion is executed first, at step 100. When a critical portion of the primary program is activated, the method implements a step 102 for executing the critical portion of the primary program via the data processing means of device D1, thereby delivering first output data 31 based on input data 20. The securing method simultaneously and sequentially implements a step 104 for execution of the same critical portion by the checking program 12, thereby delivering second output data 32 based on the same input data 20. To accomplish this, the primary program 11 is capable of transmitting information 33 to the checking program 12 indicating the critical portion of the primary program 11 which is executed at step 102.

The checking program carries out the same processing, i.e., (in the absence of a bug) it is supposed to provide the same output data as the primary program, in the presence of the same input data. On the other hand, it is structurally different so as to enable detection of these bugs. It was generated, for example, by another compiler or written by a human.

A step 106 for comparing the first and second output data 31, 32 is then implemented in the comparison means 13 of the processing means contained in device D1. It is then determined if these first and second output data 31, 32 are different. In the case where there are no differences between the first and second output data 31, 32, execution of the primary program 11 can continue according to step 100.

In the case where the first and second output data 31, 32 are different, anomaly information 35 is generated as output from the comparison means 13, according to step 108, and the primary program 11 continues, on the basis of the first output data 31. The existence of a discrepancy between the first and second output data 31, 32 may in actual practice correspond to an anomaly or error in a critical portion of the primary program 11, which preferably does not have any impact on the operation of device D1 or which contributes to a minor malfunction of device D1.

In this embodiment, the anomaly information 35 generated in step 108 can be reported immediately to a remote server S, in step 110, by means of a known type of communication network. The server S is capable of processing the anomaly information 35 immediately (step 112) or of possibly storing it in order to take the necessary corrective measures with respect thereto, at a non-real time moment. When the server S has determined a correction for the anomaly in step 114, it transmits this correction to at least device D1 in step 116.

In an alternative embodiment, step 108 includes the generation of a report containing a set of information relating to the anomaly, including the input data 20 and output data 31, 32, which is intended to enable rapid identification of the origin of the anomaly and the necessary correction. In another alternative embodiment, the report containing a set of information relating to said anomaly can be stored in storage means of device D1, and transmitted off-line to the remote server S (step 110).

The securing method can implement a step for device D1 to receive information for correcting 40 the primary program 11, which is transmitted by the remote server S. Device D1 can thereby secure the use of the primary program 11, without there being any prolonged interruption in the operation thereof.

The securing method can likewise additionally or alternatively include a step for device D1 to receive a command to interrupt or modify (referenced as 41 in FIG. 1) the primary program 11, which is transmitted by the server S.

In this way, the server S can remotely control modification of the primary program 11 of device D1 or the interruption of the primary program 11, if the detected anomaly so requires it, or the modification of the behaviour of the primary program 11, e.g., for it to shift to a degraded or secure operating mode, in particular to prevent the anomaly from reproducing (e.g., by preventing the use of the portion of the code having generated the anomaly) and/or to mitigate the possible consequences of the anomaly (e.g., by blocking the bank card which generated the anomaly, by flagging the anomaly to the user (in particular in a vehicle or on an industrial site), and/or by securing the device, the equipment thereof or the environment thereof (in particular for military or nuclear applications)).

According to the updating method of an aspect of the disclosure, the principal steps of which are detailed in FIG. 3, the server S can correct or update a primary program driving at least one of the devices D1 to Dn, as soon as an anomaly has been detected by the checking program of at least one of the devices D1 to Dn. The remote server S thus includes means of receiving anomaly information (step 211) transmitted by one of the devices D1 to Dn. By means of integrated processing means, the server determines a correction for the anomaly in step 214. To accomplish this, the server S analyzes the anomaly information (step 214A) and produces a corrective measure for the anomaly (step 214b), and then, in step 216, sends the corrective measure for the anomaly (referenced as 40 in FIG. 1) to the device which transmitted the anomaly information, or simultaneously to devices D1 to Dn, if the same primary program is implemented on all these devices.

The technique implemented by an aspect of the disclosure is advantageous in that checking of the primary program 11, which is used for a critical application, is carried out in an on-going and unimpeded manner, even after the testing phase for the primary program 11. Checking of the primary program 11 is carried out during the “production phase” of the primary program and is therefore based on stimuli which could not have been anticipated during the testing phase. In the case where an anomaly is detected in the primary program 11, the anomaly is transmitted to the remote server S, which enables a quick and effective reaction in order to correct this anomaly without impeding the execution of the primary program 11 (except in certain embodiments, if the anomaly so justifies it).

Accordingly, an aspect of the disclosure improves the security of the programs, and particularly critical programs.

An aspect of the disclosure enables the duration of the testing phase to be reduced, without greatly reducing the security of the program.

An aspect of the disclosure enables detecting a possible anomaly in a manner that is easy to implement.

Another aspect of the disclosure enables a quick and effective reaction in the case where an anomaly is detected in such programs.

Although the present disclosure has been described with reference to one or more examples, workers skilled in the art will recognize that changes may be made in form and detail without departing from the scope of the disclosure and/or the appended claims.

What is claimed is:

1. A method of securing a primary computer program driving at least one data receiving and delivery device,
said method implementing a secondary computer checking program, which is different from said primary program and which is capable of delivering the same output data as at least a portion of said primary program, referred to as a critical portion, in the presence of identical input data,
said method comprising the following steps, when at least one of said critical portions of said primary program is activated:
execution of said critical portion, delivering first output data based on input data;
execution of said checking program, delivering second output data based on said input data;
comparison of said first and second output data and generation of anomaly information, if said first and second output data are different;
transmission of said anomaly information to a remote server with a view to non-real time analysis and correction of said primary program;
continuation of said primary program, based on said first output data.

2. The method of claim 1, wherein said transmission step includes transmission of a report containing a set of information relating to said anomaly, including said input data and said output data, which enables identification of an origin of the anomaly and correction thereof.

3. The method of claim 1, further comprising a step of receiving corrective information for said primary program, which is transmitted by said server.

4. The method of claim 1, further comprising a step of receiving a command to interrupt or modify said primary program, which is transmitted by said server.

5. The method of claim 1, further comprising a step of storing a report containing a set of information relating to said anomaly.

6. A device comprising:
data processing means delivering output data based on input data, said processing means comprising means of implementing a primary computer program,
means of implementing a secondary computer checking program, which is different from said primary program, and which is capable of delivering the same output data as at least a portion of said primary program, referred to as a critical portion, in the presence of identical input data,
said device implementing, when at least one of said critical portions of said primary program is activated:
means of executing at least one of said critical portions of said primary program, delivering first output data based on input data;
means of executing said checking program, delivering second output data based on said input data;
means of comparing said first and second output data and generation of anomaly information, if said first and second output data are different;
means of transmitting said anomaly information to a remote server, with a view to non-real time analysis and correction of said primary program; and
wherein said means of executing said primary program continues processing on the basis of said first output data.

7. The device of claim 6, wherein the device belongs to the group comprising:
smart card-reading terminals, in particular bank terminals;
data servers, in particular bank servers;
financial or stock transaction devices;
devices for monitoring medical applications, and particularly drug administration;
engine control devices;
railway signalling devices;
aircraft piloting devices;
on-board motor vehicle devices;
devices for monitoring industrial sites, particularly energy production;
telecommunications devices;
devices used in military applications.

8. A method for updating in a remote server of a primary computer program driving at least one data receiving and delivery device, which implements a securing method that implements a secondary computer checking program, which is different from said primary program and which is capable of delivering the same output data as at least a portion of said primary program, referred to as a critical portion, in the presence of identical input data, wherein the securing method comprises the following steps, when at least one of said critical portions of said primary program is activated:
execution of said critical portion, delivering first output data based on input data;
execution of said checking program, delivering second output data based on said input data;
comparison of said first and second output data and generation of anomaly information, if said first and second output data are different;
transmission of said anomaly information to the remote server;
wherein the method for updating comprises the following steps:
reception of the anomaly information transmitted by one of said devices, when the comparison of first data delivered by a primary program in the presence of particular input data differs from second output data delivered by the checking program;
analysis of said anomaly and production of a corrective measure;
transmission of said corrective measure to said device issuing said anomaly information.

9. The method for updating of claim 8, wherein said corrective measure is transmitted simultaneously to a set of devices implementing said primary program.

10. An update server for a primary program driving at least one data receiving and delivery device, said device implementing a securing method that implements a secondary computer checking program, which is different from said primary program and which is capable of delivering the same output data as at least a portion of said primary program, referred to as a critical portion, in the presence of identical input data, wherein the securing method comprises the following steps, when at least one of said critical portions of said primary program is activated:
execution of said critical portion, delivering first output data based on input data;
execution of said checking program, delivering second output data based on said input data;
comparison of said first and second output data and generation of anomaly information, if said first and second output data are different;
transmission of said anomaly information to the remote server;
wherein the update server comprises:
means for receiving the anomaly information transmitted by one of said devices, when the comparison of first data delivered by a primary program in the presence of particular input data differs from second output data delivered by the checking program;
means of analyzing said anomaly and production of a corrective measure;
means of transmitting said corrective measure to said device issuing said anomaly information.
